(19) United States
(12) Patent Application Publication
(10) Pub. No.: US 2013/0215857 A1
(43) Pub. Date: Aug. 22, 2013

(54) Method of Downlink Power Allocation

(71) Applicants: Huaming Wu, San Diego, CA (US); Yu Ngok Li, Shenzhen City (CN); Senbao Guo, Shaanxi (CN); Yan Xue, Shenzhen (CN); Changqing Zhu, Shaanxi (CN); Yunfeng Sun, Shaanxi (CN)

(72) Inventors: Huaming Wu, San Diego, CA (US); Yu Ngok Li, Shenzhen City (CN); Senbao Guo, Shaanxi (CN); Yan Xue, Shenzhen (CN); Changqing Zhu, Shaanxi (CN); Yunfeng Sun, Shaanxi (CN)

(21) Appl. No.: 13/877,957

(22) PCT Filed: Oct. 9, 2010
(86) PCT No.: PCT/CN10/77622

§ 371 Date: Apr. 5, 2013

(51) Int. Cl. H04W 72/04

(52) U.S. Cl. CPC H04W 72/0473
USPC 370/329

(57) ABSTRACT

A method of downlink power allocation is provided in order to fully utilize the available power and to avoid imbalanced power in different symbols. The method comprising muting a cell's resource elements (REs) that correspond to locations of common reference signal (CRS) REs of an interfering cell, and allocating unused power of the muted REs to CRS REs or a Physical Downlink Shared Channel (PDSCH) data RE of the cell after the muting.

### TECHNICAL FIELD

This invention relates to the mechanism of downlink power allocation depending on the muting of resource elements.

### BACKGROUND OF THE INVENTION

Heterogeneous network deployments consist of deployments where low power nodes (LPN) are placed throughout a macro-cell layout. There are several types of low power nodes. For example, a femto cell is a small cellular base station, typically designed for use in home or small business. It connects to the service provider's network via broadband (such as DSL or cable). A femto cell allows service providers to extend service coverage indoors, especially where access would otherwise be limited or unavailable. In 3GPP terms, a Long Term Evolution (LTE) femto-cell is called a Home eNode B (HeNB). Typically, the HeNB has no direct interface (e.g, X2 interface in 3GPP) to other femto cells or any Macro eNodeB (MeNB).

However, when deployed in the same channel, there is a severe interference problem for macro and femto User Equipments (UE). For instance, when a macro UE is in the vicinity of a femto cell, the signal from the femto cell base station is interfering with the signal from the macro cell. In such case, the macro UE may report radio link failure (RLF) to its serving macro cell. According to current 3GPP standard, such as 3GPP TS 36.133, Requirements for support of radio resource management, and 3GPP TS 36.213: “Evolved Universal Terrestrial Radio Access (E-UTRA); Physical layer procedures”, the UE shall monitor the downlink link quality based on the cell-specific reference signal (e.g., common reference signal (CRS) in LTE) in order to detect the downlink radio link quality of the serving cell. The CRS of a macro cell may be received by a macro UE with other interfering signal from an adjacent femto cell as well as other neighbouring macro cells. In some case, the signal to interference and noise ratio (SINR) is lower than a threshold which in turn would cause the UE to report link failure. However, if some inter-cell interference coordination techniques such as almost blank subframe proposed in 3GPP R1-103561, Improving control reliability in severe interference conditions, is used, there may be no or negligible interference during actual transmission. The traditional radio link monitoring doesn't reflect the actual channel quality during actual transmission and hence may create unnecessary declaration of radio link failure.

Some interference management methods for radio link monitoring have been proposed. For example, a method of symbol-level time offset between HeNB and MeNB; and a method that HeNB performs resource element (RE) muting for the REs used by macro eNB's CRS is proposed in 3GPP R1-104659, Evaluation of control channel coordination in co-channel CSG deployment. There is no power allocated to the muted REs.

In Rel-8/9 of 3GPP TS 36.213: “Evolved Universal Terrestrial Radio Access (E-UTRA); Physical layer procedures”, only certain power ratios of Physical Downlink Shared Channel (PDSCH) Energy Per Resource Element (EPRE) to cell-specific reference signal (RS) EPRE among PDSCH REs are specified. The ratio of PDSCH EPRE to cell-specific RS EPRE among PDSCH REs (not applicable to PDSCH REs with zero EPRE) for each Orthogonal Frequency Division Multiplexing (OFDM) symbol is denoted by either ρ_{A} or ρ_{B} according to the OFDM symbol index as given by Table 1.

TABLE 1
OFDM symbol indices within a slot where the ratio of the corresponding
PDSCH EPRE to the cell-specific RS EPRE is denoted by ρ_{A} or ρ_{B}

| | OFDM symbol indices | | OFDM symbol indices | |
|---|---|---|---|---|
| | within a slot where the | | within a slot where the | |
| | ratio of the corresponding | | ratio of the corresponding | |
| | PDSCH EPRE to the | | PDSCH EPRE to the | |
| | cell-specific RS EPRE | | cell-specific RS EPRE | |
| | is denoted by ρ_{A} | | is denoted by ρ_{B} | |
| | | Extended | | Extended |
| Number of | Normal cyclic | cyclic | Normal cyclic | cyclic |
| antenna ports | prefix | prefix | prefix | prefix |
| One or two | 1, 2, 3, 5, 6 | 1, 2, 4, 5 | 0, 4 | 0, 3 |
| Four | 2, 3, 5, 6 | 2, 4, 5 | 0, 1, 4 | 0, 1, 3 |

The cell-specific ratio ρ_{B}/ρ_{A} is given by Table 2 according to cell-specific parameter P_{B} signaled by higher layers and the number of configured eNodeB cell specific antenna ports.

TABLE 2
The cell-specific ratio ρ_{B}/ρ_{A} for 1, 2, or 4 cell specific antenna ports

ρ_{B}/ρ_{A}

| P_{B} | One Antenna Port | Two and Four Antenna Ports |
|---|---|---|
| 0 | 1 | 5/4 |
| 1 | 4/5 | 1 |
| 2 | 3/5 | 3/4 |
| 3 | 2/5 | 1/2 |

If power allocation is unchanged without considering the muted REs, power imbalance between different symbols would happen. Also, power is not fully utilized if power allocation is not re-designed based on the new RE muting patterns.

### SUMMARY OF THE INVENTION

In order to avoid power imbalance between different symbols and to achieve fully utilization of power, the present invention provides a method of downlink power allocation, comprising steps of:

muting a cell's resource elements (REs) that correspond to locations of common reference signal (CRS) REs of an interfering cell; and

allocating unused power of the muted REs to CRS REs or a Physical Downlink Shared Channel (PDSCH) data RE of the cell after the muting.

Preferably, part of the unused power of the muted REs is allocated to the PDSCH data RE of the cell and part of the unused power of the muted REs is allocated to CRS REs of the cell.

Preferably, the unused power of the muted REs is allocated to the CRS REs of the cell when the number of CRS antenna ports of the cell is the same as the number of CRS antenna ports of the interfering cell.

Preferably, the unused power of the muted REs is allocated to the PDSCH data RE of the cell when the number of CRS antenna ports of the cell is different from the number of CRS antenna ports of the interfering cell.

Preferably, the method further comprises the following step before the step of allocating the unused power of the muted REs:

defining different tables of cell-specific ratio depending on the number of muted CRS patterns.

Preferably, the method further comprises the following step before the step of allocating the unused power of the muted REs:

defining a new table to specify OFDM symbol indices within a slot where the ratio of the corresponding PDSCH EPRE to the cell-specific RS EPRE have 3 different types, i.e., ρ_{A} or ρ_{B} or ρ_{C}.

Preferably, the step of defining different tables of cell-specific ratio comprises:

defining a new table of cell-specific ratio for the OFDM symbol 1 for one and two antenna ports.

Preferably, the method further comprises:

defining a new cell-specific parameters P_{C} to index to the new table of cell-specific ratio for the OFDM symbol 1.

Preferably, the method further comprises:

performing resource allocation according to a cell-specific ratio in a table chosen from the different tables of cell-specific ratio.

Preferably, the table is chosen from the different tables of cell-specific ratio according to a current number of muted CRS patterns.

Preferably, the cell-specific ratio in the table is determined based on a cell-specific parameter signaled by higher layers.

Preferably, the method further comprises:

calculating power at user equipment for receiving data and reference signals based on the cell-specific ratio in the table.

With the method of the present invention, the unused power of the muted REs can be allocated to the CRS REs of HeNB or the PDSCH data RE of HeNB, thereby fully utilizing the available power and avoiding imbalanced power in different symbols.

### BRIEF DESCRIPTION OF THE DRAWINGS

FIG. 1 illustrates RE locations of PDSCH data and different reference signals;

FIG. 2 illustrates the flow of power allocation based on the number of muted CRS patterns using multiple tables for each cell-specific ratio; and

FIG. 3 illustrates the flow of power allocation based on the number of muted CRS patterns using one table for each cell-specific ratio.

### PREFERRED EMBODIMENTS OF THE INVENTION

To fully utilize the available power and to avoid imbalanced power in different symbols, power allocation is needed to be re-designed. The basic idea of this invention is to have different power allocation depending on the number of muting patterns corresponding to the CRS patterns. This mechanism can be applied to 3GPP LTE/LTE-Advanced systems.

Preferred embodiments of the present invention are described below in conjunction with the drawings.

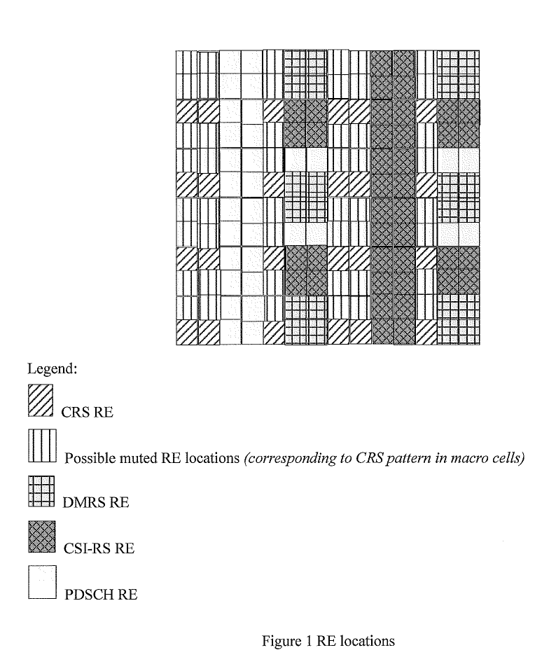

FIG. 1 shows RE locations of the PDSCH data and different reference signals. As shown in FIG. 1, CRS REs from different cells are located in the same symbols if the number of CRS antenna ports are the same for eNB1 and eNB2. The muted REs of eNB1 are corresponding to the CRS RE locations of eNB2. Therefore, after muting, the unused power of these muted REs can be allocated to CRS REs of eNB1. Alternatively, the unused power can be allocated to the PDSCH data RE of eNB1. It is necessary if the number of CRS antenna ports are different in eNB1 and eNB2. In this case, not all the CRS REs of these two cells are in the same symbol and hence the unused power of muted REs cannot be allocated to eNB1 CRS. The unused power of these muted REs can be allocated to PDSCH data RE of eNB1 in this case. To support this power re-allocation, a new ratio ρ_{C} has to be defined for the case that the muted REs are in the symbol without the CRS REs of the serving cell. New tables for cell-specific ratios ρ_{B}/ρ_{A} and ρ_{C}/ρ_{A} are needed to be defined. Here we have several tables for the cases when number of muted CRS patterns are 1, 2 and 3 respectively. eNB1 and eNB2 can be HeNB and macro eNB respectively.

TABLE 3-1
OFDM symbol indices within a slot where the ratio of the corresponding PDSCH EPRE to
the cell-specific RS EPRE is denoted by ρ_{A} or ρ_{B} or ρ_{C}

| | OFDM symbol indices | | OFDM symbol indices | | OFDM symbol indices | |
|---|---|---|---|---|---|---|
| | within a slot where the ratio | | within a slot where the ratio | | within a slot where the ratio | |
| | of the corresponding | | of the corresponding | | of the corresponding | |
| | PDSCH EPRE to the cell- | | PDSCH EPRE to the cell- | | PDSCH EPRE to the cell- | |
| Number | specific RS EPRE is | | specific RS EPRE is | | specific RS EPRE is | |
| of | denoted by ρ_{A} | | denoted by ρ_{B} | | denoted by ρ_{C} | |
| antenna | Normal cyclic | Extended | Normal cyclic | Extended | Normal cyclic | Extended |
| ports | prefix | cyclic prefix | prefix | cyclic prefix | prefix | cyclic prefix |
| One or | 2, 3, 5, 6 | 2, 4, 5 | 0, 4 | 0, 3 | 1 | 1 |
| two | | | | | | |
| Four | 2, 3, 5, 6 | 2, 4, 5 | 0, 1, 4 | 0, 1, 3 | N/A | N/A |

TABLE 3-2
The cell-specific ratio ρ_{B}/ρ_{A} for 1, 2, or 4 cell specific antenna ports
when number of muted CRS patterns is 1

ρ_{B}/ρ_{A}

| | | Two and Four Antenna |
|---|---|---|
| P_{B} | One Antenna Port | Ports |
| 0 | 5/3 | 5/2 |
| 1 | 4/3 | 2 |
| 2 | 5/4 | 5/3 |
| 3 | 1 | 3/2 |
| 4 | 4/5 | 4/3 |
| 5 | 3/4 | 5/4 |
| 6 | 3/5 | 1 |
| 7 | 1/2 | 3/4 |
| 8 | 2/5 | 2/3 |
| 9 | Reserved | 1/2 |

TABLE 3-3
The cell-specific ratio ρ_{C}/ρ_{A} for 1 or 2 cell specific antenna ports when
number of muted CRS patterns is 1

| | ρ_{C}/ρ_{A} |
|---|---|
| P_{C} | One and Two Antenna Ports |
| 0 | 3/2 |
| 1 | 1 |

TABLE 3-4
The cell-specific ratio ρ_{B}/ρ_{A} for 1, 2, or 4 cell specific antenna ports when
number of muted CRS patterns is 2

ρ_{B}/ρ_{A}

| | | Two and Four Antenna |
|---|---|---|
| P_{B} | One Antenna Port | Ports |
| 0 | 5 | 5 |
| 1 | 4 | 4 |
| 2 | 3 | 3 |
| 3 | 5/2 | 5/2 |
| 4 | 2 | 2 |
| 5 | 3/2 | 3/2 |
| 6 | 5/3 | 5/4 |
| 7 | 4/3 | 1 |
| 8 | 1 | 3/4 |
| 9 | 4/5 | 1/2 |
| 10 | 2/3 | Reserved |
| 11 | 3/5 | Reserved |
| 12 | 2/5 | Reserved |

TABLE 3-5
The cell-specific ratio ρ_{C}/ρ_{A} for 1 or 2 cell specific antenna ports when
number of muted CRS patterns is 2

| | ρ_{C}/ρ_{A} |
|---|---|
| P_{C} | One and Two Antenna Ports |
| 0 | 3 |
| 1 | 3/2 |
| 2 | 1 |
| 3 | Reserved |

Or we can use one table to represent the Tables 3-3 and 3-5 for the cell-specific ratio ρ_{B}/ρ_{A} as shown in Table 3-6 below.

TABLE 3-6
The cell-specific ratio ρ_{B}/ρ_{A} for 1, 2, or 4 cell specific antenna ports

| | | Two and Four Antenna |
|---|---|---|
| | One Antenna Port | Ports |
| 0 | 5 | 5 |
| 1 | 4 | 4 |
| 2 | 3 | 3 |
| 3 | 5/2 | 5/2 |
| 4 | 2 | 2 |
| 5 | 3/2 | 5/3 |
| 6 | 5/3 | 3/2 |
| 7 | 4/3 | 4/3 |
| 8 | 1 | 5/4 |
| 9 | 5/4 | 1 |
| 10 | 4/5 | 3/4 |
| 11 | 3/4 | 2/3 |
| 12 | 2/3 | 1/2 |
| 13 | 3/5 | Reserved |
| 14 | 1/2 | Reserved |
| 15 | 2/5 | Reserved |

Similarly, we can use one table to represent the Tables 3-2 and 3-4 for the cell-specific ratio ρ_{C}/ρ_{A} as shown in Table 3-7 below.

TABLE 3-7
The cell-specific ratio ρ_{C}/ρ_{A} for 1 or 2 cell specific antenna ports.

| | ρ_{C}/ρ_{A} |
|---|---|
| P_{C} | One and Two Antenna Ports |
| 0 | 3 |
| 1 | 3/2 |
| 2 | 1 |
| 3 | Reserved |

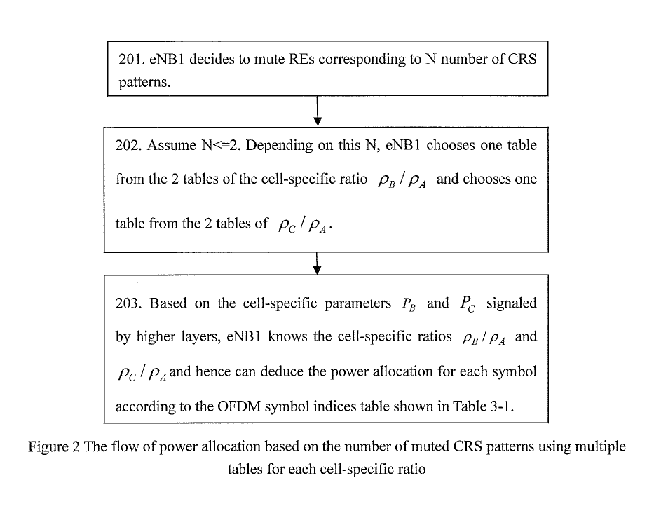

FIG. 2 shows the flow of power allocation based on the number of muted CRS patterns according to the present invention, comprising steps of:

201. eNB1 decides to mute REs corresponding to N number of CRS patterns;

202. Assume N<=2. Depending on this N, eNB1 chooses one table from 2 tables of the cell-specific ratio ρ_{B}/ρ_{A} and chooses one table from 2 tables of ρ_{C}/ρ_{A}.

203. Based on the cell-specific parameters P_{B} and P_{C} signaled by higher layers, eNB1 knows the cell-specific ratios ρ_{B}ρ_{A} and ρ_{C}/ρ_{A} and hence can deduce the power allocation for each symbol according to the OFDM symbol indices table shown in Table 3-1.

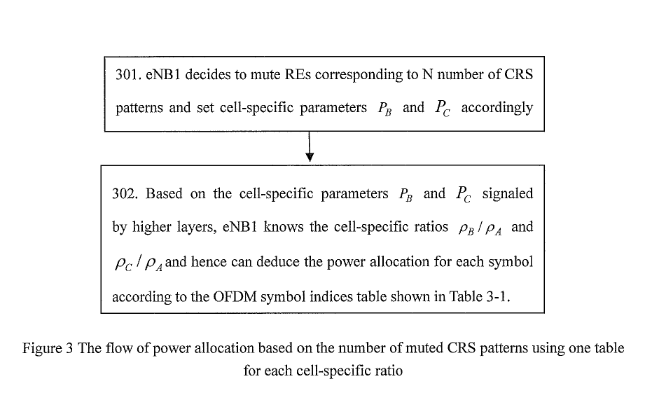

FIG. 3 shows the flow of power allocation based on the number of muted CRS patterns according to the present invention if only one unified table is defined each for, comprising steps of:

301. eNB1 decides to mute REs corresponding to N number of CRS patterns and set cell-specific parameters P_{B} and P_{C} accordingly at higher layers.

302. Based on the cell-specific parameters P_{B} and P_{C} signaled by higher layers, eNB1 knows the cell-specific ratios ρ_{B}/ρ_{A} and ρ_{C}ρ_{A} and hence can deduce the power allocation for each symbol according to the OFDM symbol indices table shown in Table 3-1.

At the UE side, power calculation is performed for receiving data and RS signal by looking up the table depending on the number of muted CRS patterns for the cell-specific ratio.

Other variations and enhancements are possible based on the preferred embodiments described above. It shall be understood that the above detailed description of the preferred embodiments of the present invention is not limitation to the protection scope of the present invention, which is defined by the claims.

### INDUSTRIAL APPLICABILITY

The method of downlink resource allocation provided in the present invention can be applied to 3GPP LTE/LTE-Advanced systems. According to the present invention, the unused power of the muted REs can be allocated to the CRS REs of HeNB or the PDSCH data RE of HeNB, thereby fully utilizing the available power and avoiding imbalanced power in different symbols.

1. A method of downlink power allocation, comprising steps of:
muting a cell's resource elements (REs) that correspond to locations of common reference signal (CRS) REs of an interfering cell; and
allocating unused power of the muted REs to CRS REs or a Physical Downlink Shared Channel (PDSCH) data RE of the cell after the muting.

2. The method as claimed in claim 1, wherein part of the unused power of the muted REs is allocated to the PDSCH data RE of the cell and part of the unused power of the muted REs is allocated to CRS REs of the cell.

3. The method as claimed in claim 1, wherein the unused power of the muted REs is allocated to the CRS REs of the cell when the number of CRS antenna ports of the cell is the same as the number of CRS antenna ports of the interfering cell.

4. The method as claimed in claim 1, wherein the unused power of the muted REs is allocated to the PDSCH data RE of the cell when the number of CRS antenna ports of the cell is different from the number of CRS antenna ports of the interfering cell.

5. The method as claimed in claim 1, further comprising the following step before the step of allocating the unused power of the muted REs:
defining different tables of cell-specific ratio depending on the number of muted CRS patterns.

6. The method as claimed in claim 5, further comprising the following step before the step of allocating the unused power of the muted REs:
defining a new table to specify Orthogonal Frequency Division Multiplexing (OFDM) symbol indices within a slot where the ratio of the corresponding PDSCH Energy Per Resource Element (EPRE) to the cell-specific reference signal (RS) EPRE have 3 different types.

7. The method as claimed in claim 5, wherein the step of defining different tables of cell-specific ratio comprises:
defining a new table of cell-specific ratio for Orthogonal Frequency Division Multiplexing (OFDM) symbol 1 for one and two antenna ports.

8. The method as claimed in claim 7, further comprising:
defining a new cell-specific parameter to index to the new table of cell-specific ratio for the OFDM symbol 1.

9. The method as claimed in claim 5, further comprising:
performing resource allocation according to a cell-specific ratio in a table chosen from the different tables of cell-specific ratio.

10. The method as claimed in claim 9, wherein the table is chosen from the different tables of cell-specific ratio according to a current number of muted CRS patterns.

11. The method as claimed in claim 9, wherein the cell-specific ratio in the table is determined based on a cell-specific parameter signaled by higher layers.

12. The method as claimed in claim 9, further comprising:
calculating power at user equipment for receiving data and reference signals based on the cell-specific ratio in the table.
